(19) United States
(12) Patent Application Publication
(10) Pub. No.: US 2026/0087735 A1
(43) Pub. Date: Mar. 26, 2026

(54) SYSTEM, METHOD, COMPUTER PROGRAM AND COMPUTER-READABLE MEDIUM FOR GENERATING ANNOTATED DATA

(71) Applicant: Rohde & Schwarz GmbH & Co. KG, Munich (DE)

(72) Inventors: Christian SCHÜSSLER, Nürnberg (DE); Marcel HOFFMANN, Zirndorf (DE); Martin VOSSIEK, Fürth (DE)

(21) Appl. No.: 19/112,696

(22) PCT Filed: Sep. 20, 2023
(86) PCT No.: PCT/EP2023/075940

§ 371 Date: Mar. 18, 2025

(30) Foreign Application Priority Data
Sep. 21, 2022 (DE) 102022124257.9

(51) Int. Cl. G06T 17/00; G01S 13/86; G01S 13/931; G01S 17/86; G01S 17/89; G01S 17/931; G06V 20/58; G06V 20/70

(52) U.S. Cl. CPC G06T 17/00; G01S 13/867; G01S 13/931; G01S 17/86; G01S 17/89; G01S 17/931; G06V 20/58; G06V 20/70

(57) ABSTRACT

The present invention relates to a system for detecting, classifying and/or segmenting an object and/or a property of an object with a simulation unit and an artificial intelligence unit, wherein the simulation unit is configured to generate simulated measurement data of a simulated sensor unit about a virtual object and/or a property of a virtual object in a virtual environment and to annotate the virtual object, the property of the virtual object and/or the virtual environment and to generate simulation data therefrom, wherein the artificial intelligence unit is configured to detect, classify and/or segment, based on the simulated measurement data and the simulation data, an object and/or a property of an object based on the simulated measurement data or based on other simulated measurement data and/or based on measurement data generated from a real measurement.

The present invention relates to a system for detecting, classifying and/or segmenting an object and/or a property of an object with a simulation unit and an artificial intelligence unit, wherein the simulation unit is configured to generate simulated measurement data of a simulated sensor unit about a virtual object and/or a property of a virtual object in a virtual environment and to annotate the virtual object, the property of the virtual object and/or the virtual environment and to generate simulation data therefrom.

For the simulation of radar and/or radio signals in general, a number of different approaches based on ray tracing algorithms are known from the prior art.

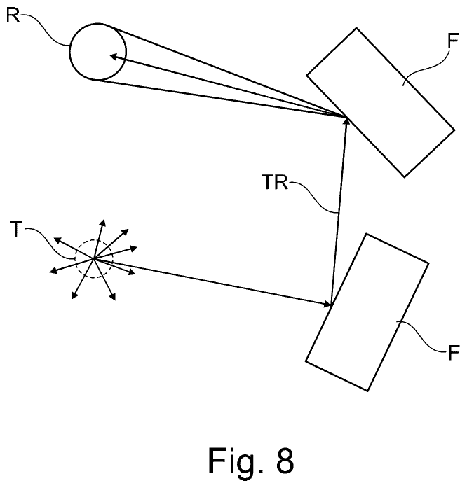

A widely used approach, especially for the simulation of radar data in the automotive field, is the Shooting and Bouncing Rays (SBR) approach. It is illustrated in FIG. 8. A beam TR emanating from a transmit antenna T is reflected at the facets F and is received by the receive antenna R.

A computation-efficient variant for the simulation of radar data is to describe the object by means of so-called scattering targets. These scattering target models may be created by measurements or by a more complex SBR simulation. A significant disadvantage of this technique is that scattering centers have to be calculated or measured individually for each object and effects such as occlusion or multiple reflections cannot be simulated or can only be simulated to a very limited extent, which makes realistic simulation more difficult overall.

The increased use of neural networks has also led to the development of data-driven approaches. In this case, a statistical model or an artificial neural network learns to generate new unknown radar data artificially from measured radar data. The greatest disadvantage of this variant is that only data from existing sensors may be generated with existing measurement data. A flexible or random sensor configuration is therefore not readily possible here, in contrast to the ray tracing approaches.

Furthermore, the quality and/or closeness to reality of the generated data of the two last-mentioned methods is still noticeably worse in comparison to a largely physically correct SBR simulation.

According to the prior art, artificial intelligence is used in the field of the detection and classification of objects in the automotive radar environment. The spectrum of application ranges from the simple detection of objects to the classification thereof, which often takes place using the Doppler spectrum.

Machine learning algorithms, i.e. artificial intelligence, are also used to improve the angular resolution.

Furthermore, artificial intelligence is used to improve images in the field of radar imaging and in the field of human motion classification.

One of the greatest problems when using artificial intelligence for radar signals is the generation of a so-called ground truth. This requires the annotation of data, whereby labels that are as precise as possible, such as “pedestrian”, “cyclist” or “car” etc., are assigned to as many individual areas and/or parts of the radar data as possible.

The simplest approach for generating ground truth is a manual annotation, but this represents a considerable effort, particularly in the case of large data volumes.

Unlike in the case of radar data, the manual annotation of natural images, e.g. of photos, is complex, but is possible in principle by sufficient personnel. In the case of radar data, this is not easily the case. Radar data can only be effectively classified by expert knowledge, since they differ greatly from natural images and are therefore difficult to interpret by humans. However, not all radar image effects can be correctly classified even with expert knowledge.

Compared with optical images based on visible light, this is mainly related to the different reflection behavior of electromagnetic waves in the frequency range of conventional radar systems, the lower (angular) resolution and the different data processing.

For example, even side lobes in the frequency spectrum of a target reflection still belong to the actual target, although they are locally partially far away. Also, a single object may image multiple target detections in the radar image by multiple reflections, which are locally far away from one another.

Another possibility for generating ground truth data is to automatically annotate it. This type of learning is often referred to as self-supervised.

It is known to annotate processed radar point clouds semi-automatically by means of a lidar sensor and/or a camera sensor.

GPS and/or odometry sensors may also be used as a reference, e.g. in lane estimation and/or road course estimation.

Furthermore, simulations are already used to create ground truth data for radar applications.

However, simulations are used only to a very limited extent for the classification of individual objects. Comprehensive automatic segmentation of complex simulation scenarios on the basis of raw radar data, which is essential for use in the automotive radar environment, is not known.

One reason for this is not only that it is very complex and computationally intensive to simulate complex worlds. A fundamental problem is also that, even in simulations, the 3D environment must be correctly translated into the simulation data. This means that each object and/or even each reflection in the radar signal must be correctly annotated or labeled.

With this background in mind, the present invention is based on the task of improving an aforementioned system, in particular with respect to the annotation of objects.

This task is solved by the method with the features of independent claim 1. Advantageous developments of the invention are subject of the dependent claims.

Accordingly, it is provided according to the invention that the artificial intelligence unit is configured to detect, classify and/or segment, based on the simulated measurement data and the simulation data, an object and/or a property of an object based on the simulated measurement data or based on other simulated measurement data and/or based on measurement data generated from a real measurement.

The system is preferably configured for annotation and for subsequent optimal training of the artificial intelligence unit. The annotation preferably takes place in the simulation unit.

Preferably, it is possible, but not necessary, to completely annotate virtual objects in a virtual environment or virtual worlds.

A property of a virtual object is preferably any type of information which is linked to the object, such as, for example, a vectorial speed, preferably of each image point or beam which strikes the object, noise and/or side lobes which emanate from the object, temperature, material property, color, etc.

Annotation preferably refers to the process of giving an object or a pixel or an image area a label or a designation which may be interpreted by an artificial intelligence unit, particularly in a training process.

The artificial intelligence unit is preferably configured to recognize common features of objects, pixels or image areas.

Detection preferably refers to the process of recognizing an object and/or a property of an object. For example, it may be recognized by the detection whether an object is a human being or a car.

Classification preferably refers to the process of assigning an object and/or a property of an object to a class. In this case, a probability may be specified with which an object is to be assigned to a class. For example, an object may be assigned to the class “human” by classification with a probability of 96%.

Segmentation preferably refers to the process of dividing an object into segments, such as pixels, for example, wherein each segment is detected and/or classified.

Preferably, it is provided that the simulation unit is configured to simulate more than one virtual object with more than one property and/or is configured to completely annotate the virtual object and/or the property of the virtual object or the virtual objects and/or the properties of the virtual objects and/or the virtual environment.

Preferably, it is provided that the system further comprises means, by means of which a generation of the virtual object and/or a generation of the virtual environment is performed by means of 3D information, which was generated from a game engine or based on map information, aerial images, earth remote sensing information and/or measurement data of a camera system and/or a laser scanner or other sensor systems.

Preferably, it is provided that the simulated sensor unit is patterned on a real sensor unit and/or that the simulated sensor unit is improved compared to a real sensor unit, in particular with respect to resolution capability, signal-to-noise ratio and/or unambiguity ranges.

It is conceivable that the simulated sensor unit simulates a radar, a camera, a lidar and/or an ultrasound device.

Preferably, it is provided that the simulated, other simulated or measurement data generated from a real measurement are image data and/or that the artificial intelligence unit is configured to improve raw and processed sensor signals in the measurement data.

It is conceivable that the environment is a dynamic, three-dimensional environment.

Preferably, it is provided that the system or the artificial intelligence unit is part of a vehicle and/or that the measurement data generated from the real measurement was generated by a radar, a camera, a lidar and/or an ultrasound device.

In other words, image recognition may take place by the annotation.

In other words, preferably at least one object, preferably a dynamic 3D scene as diverse as possible, is simulated, for example in a game engine or based on map information or measurement data of camera systems and/or laser scanners or other sensors of a real scene or a real setup.

In this object and/or world simulation, radars are then preferably simulated which, based on their position in space and their simulated antennas, emit radar signals with a ray-tracing approach into this world and receive and evaluate the reflections, whereby digital radar ADC data may be simulated. The simulated world and the simulated signal are preferably so close to reality that the simulated signal is as similar as possible to a real signal.

Since the simulated world is known, the labels and/or annotations for the radar data may be directly and fully co-generated.

These radar data including labels may be used for training an artificial intelligence (AI), e.g. a neural network, for example for object detection, object classification, segmentation or for image enhancement.

Preferably, the simulated object and/or the simulated worlds are simulated once with and once without interference effects. Thus, neural networks may be trained which largely suppress these interference effects in reality.

Preferably, the radar modeled on reality is once simulated as a “digital twin” and once as a significantly improved “advanced digital twin”. This may, for example, have a significantly larger or fully occupied antenna array in order to simulate radar images with a better angular resolution. If a neural network and/or an AI is now trained with the simulation data of the “digital twin” and the “advanced digital twin”, the AI may improve the real radar measurement data, in particular with respect to resolution, signal-to-noise ratio, unambiguity ranges, etc.

Preferably, each beam of the ray-tracing approach receives the object ID of the object at which it was reflected as an additional attribute during a reflection. It is thus possible to assign each partial echo of an object completely to this object. This attribute therefore preferably corresponds to an optimal label and/or an optimal annotation. As a result, AI applications may be optimally trained, e.g. for object classification, because the network learns to use all information from the complete (frequency) spectrum.

Preferably, the simulated worlds map reality as closely as possible by using existing data sets from remote earth sensing, map services or aerial images.

It is conceivable that the simulated worlds are generated from real measurement data. For example, data from a measurement run with high-resolution laser scanners may be accumulated in such a way that the real world may be reconstructed in the form of triangular networks (or the like).

It is conceivable that lidar, camera or ultrasound signals are simulated instead of the radar signal.

Preferably, efficient and automated teaching and/or training of artificial intelligences for the interpretation or improvement of radar and other sensor systems is made possible.

Preferably, any objects or more comprehensive scenes and/or worlds are simulated in a simulation environment in a targeted manner. Preferably, radar ADC data or other sensor raw data that are as close to reality as possible are then generated in this simulation environment by means of ray tracing approaches. Preferably, in this case, each simulated beam (ray) is assigned one or more attributes that describe and identify all objects at which this beam was reflected and/or with which this beam has interacted.

For example, the movement of an object in the form of a velocity vector may be detected directly for each reflection point and/or each beam in maximum detail. Thus, for example, pedestrians do not have a single speed, since each point of the body moves individually. The arms swing, a leg stands, the torso moves relatively constantly, etc. Precisely this micro-Doppler signature, i.e. the interaction of all speeds, may be evaluated well by a radar and may be annotated or labeled completely correctly.

Equivalently, we may also transfer further object properties such as, inter alia, temperature (not relevant for radar), material property, color (not relevant for radar), information about the transmission channel (rain, fog, etc.) and thereby obtain advantages for AI units.

Since, therefore, each object in the raw signal may be uniquely and completely identified in a retroactive manner, the simulated data may then be used directly as automatically annotated, high-quality ground truth data for the teaching or training of artificial intelligences. By using a simulation environment, it is preferably possible to generate an arbitrarily large number of completely annotated training data in a short time.

With the taught and/or trained artificial intelligences, the sensor data may, on the one hand, be interpreted, classified, segmented or described in another way, for example. On the other hand, by adapting the simulation environment and the simulated sensors, it is also possible to generate radar data with improved properties, such as, for example, resolution and unambiguity ranges, and with drastically reduced interference effects. As a result, the parameters of machine learning algorithms may be trained automatically, i.e. self-supervised, in such a way that they significantly improve the output data of real sensors, for example by super-resolution and noise suppression.

The invention also relates to a method for detecting, classifying and/or segmenting an object and/or a property of an object with a system according to any one of the preceding claims with the following steps:
a) generating simulated measurement data of a simulated sensor unit about a virtual object and/or a property of a virtual object in a virtual environment;
b) annotating the virtual object, the property of the virtual object and/or the virtual environment and generating simulation data, wherein, based on the simulated measurement data and the simulation data, an object and/or a property of an object is detected, classified and/or segmented based on the simulated measurement data or based on other simulated measurement data and/or based on measurement data generated from a real measurement.

The invention also relates to a method for training an artificial intelligence unit of a system according to any one of claims 1 to 8, wherein the artificial intelligence unit is trained to detect, classify and/or segment, based on simulated measurement data and the simulation data, an object and/or a property of an object based on the simulated measurement data or based on other simulated measurement data and/or based on measurement data generated from a real measurement.

The training of an artificial intelligence unit preferably takes place on the basis of simulated data. The artificial intelligence unit may then preferably interpret or improve real or also simulated measurement data.

The virtual object and/or the virtual environment may be patterned on a real object and/or a real environment.

With the method, a complete annotation of the virtual object, the property of the virtual object and/or the virtual environment preferably takes place. This takes place, for example, by means of object IDs. Each reflection on the path of a beam or each movement information is preferably annotated. For example, a beam is first reflected at a static house wall and then at the arm of a pedestrian swinging at 3 m/s. This information is retained in the annotation.

The features described herein are, mutatis mutandis, preferably features of the system as well as of the method.

The invention also relates to a computer program comprising instructions which cause the system according to the invention to perform the method steps of a method according to the invention.

The invention also relates to a computer-readable medium on which the computer program according to the invention is stored.

At this point, it should be noted that the terms “a” and “an” do not necessarily refer to precisely one of the elements, although this represents a possible embodiment, but may also denote a plurality of the elements. Similarly, the use of the plural also includes the presence of the element in question in the singular and, conversely, the singular also comprises multiple of the elements in question. Furthermore, all features of the invention described herein may be combined with one another as desired or claimed isolated from one another.

Further advantages, features and effects of the present invention result from the following description of preferred embodiments with reference to the figures, in which the same or similar components are designated by the same reference numbers, and in which:

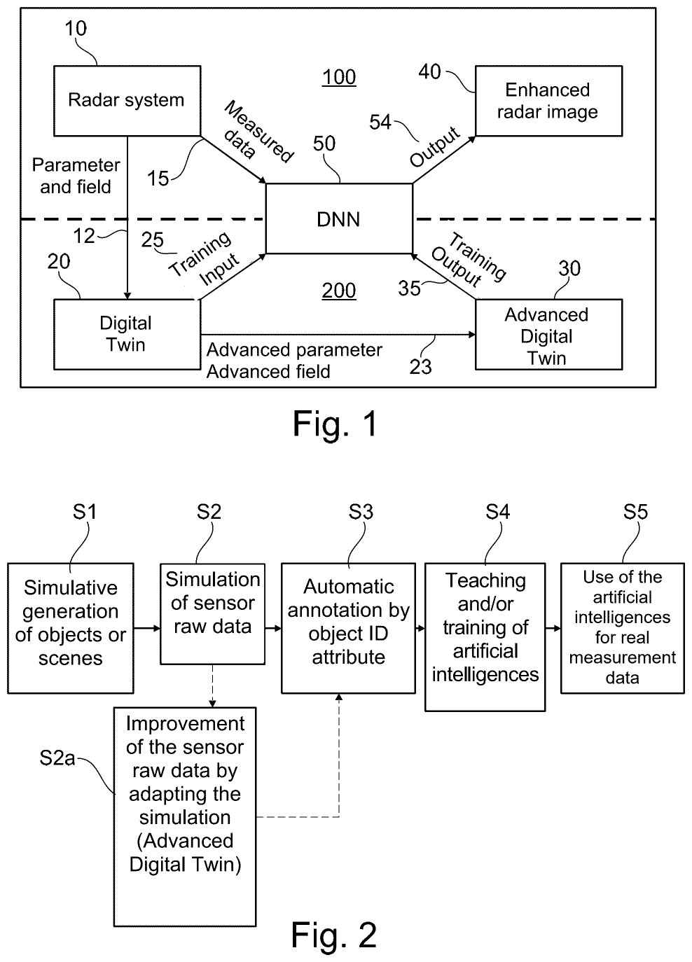

FIG. 1 shows a block diagram of an embodiment of a system according to the invention.

FIG. 2 shows a block diagram of an embodiment of a method according to the invention.

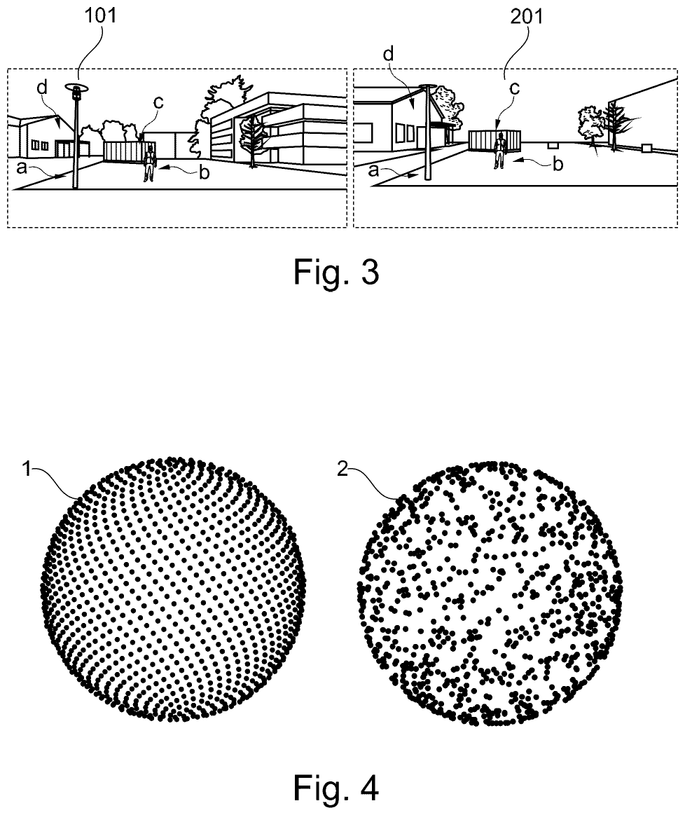

FIG. 3 shows a view of a real measurement scene (left) and a view of a three-dimensional simulation of this measurement scene (right).

FIG. 4 shows a beam pattern from a known simulation method (left) and a beam pattern from an embodiment of a simulation method according to the invention (right).

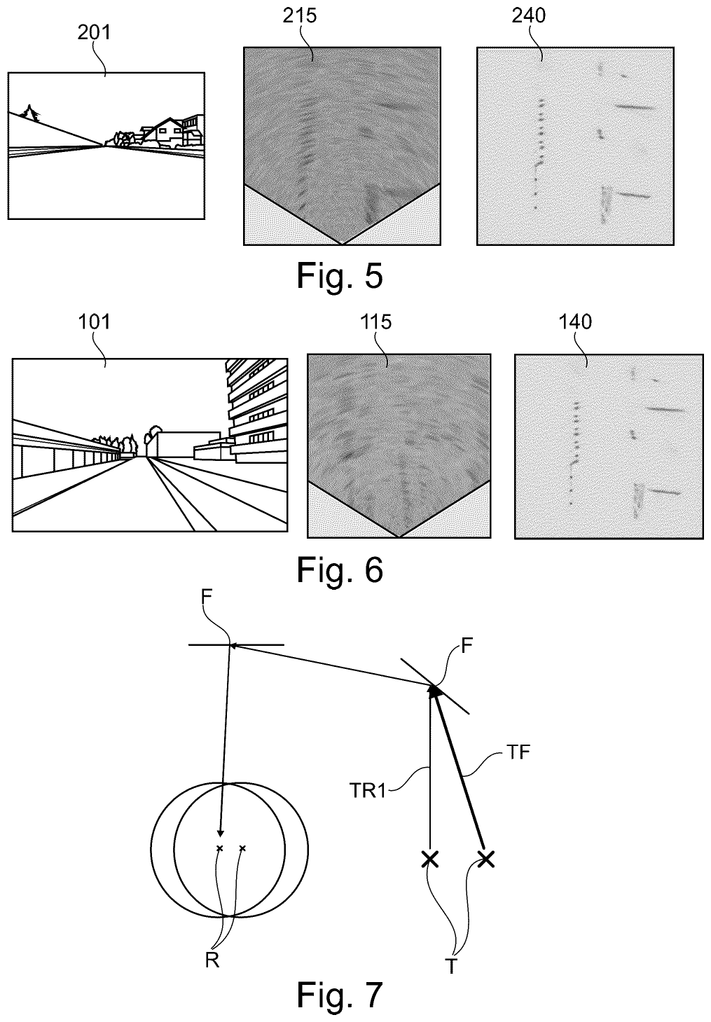

FIG. 5 shows a view of a three-dimensional simulation of a measurement scene (left), a view of a radar image based thereon (center) and a view of an extended radar image based thereon (right).

FIG. 6 shows a view of a real measurement scene (left), a view of a radar image based thereon (center) and a view of an extended radar image based thereon (right).

FIG. 7 shows a view of an antenna arrangement.

FIG. 8 shows a schematic view of an antenna arrangement.

FIG. 1 shows a block diagram of a system according to the invention with a radar system 10 and/or a “Radar System” 10, a digital twin 20 and/or a “Digital Twin” 20, an advanced digital 20 twin 30 and/or an “Advanced Digital Twin” 30 and an artificial intelligence 50 and/or a “Deep Neural Network (DNN)” 50.

An enhanced radar image 40 and/or an “Enhanced Radar Image” results as output from the system.

The units of the system may be grouped into units in reality 100 and units in virtual space 200. The radar system 10 and the enhanced radar image 40 are located in reality 100 and the digital twin 20 and the advanced digital twin 30 are located in virtual space 200. The artificial intelligence mediates between reality 100 and virtual space 200.

The radar system 10 supplies measurement data 15, for example in the form of a radar image, to the artificial intelligence 50 and parameters and information 12 about the antenna array of the radar system 10 to the digital twin 20. The digital twin 20 supplies training data 25 to the artificial intelligence 50 and advanced parameters and information 23 about the antenna array of the radar system 10 to the advanced digital twin 30. The advanced digital twin supplies training data 35 to the artificial intelligence 50. The artificial intelligence 50 processes the measurement data 50, the training data 25 and 35 and outputs an enhanced radar image 40 as output 54.

Preferably, advanced radar sensors without undesired effects are simulated in order to improve real radar images.

The artificial intelligence unit may be an attention U network trained on 9000 images for a regression task.

The distance resolution of the digital twin 20 and of the advanced digital twin 30 is preferably as small as possible, preferably smaller than or equal to that of a real sensor and is, for example, 7.5 cm. The lateral resolution of the digital twin 20 is preferably equal to that of a real sensor and is, for example, 5.3°. The lateral resolution of the advanced digital twin 30 is preferably smaller than that of a real sensor and is, in particular, smaller than 1° and is, for example, 0.4°. The advanced digital twin 30 has no or less disorder and noise in comparison to the digital twin 20. The reconstruction in the digital twin 20 takes place on the basis of a fast Fourier transform (FFT). The reconstruction in the advanced digital twin 30 takes place on the basis of a suitable filter.

A Doppler simulation of a running human being is conceivable.

FIG. 2 shows method steps of an exemplary method.

In a simulation environment, 3D maps may be exported from an open-source simulator, i.e. a simulation unit. These data consist of triangular networks that are used in the field of computer graphics, game development and computer aided design (CAD).

Similar to the computer graphics, a material may be assigned to each triangle and/or each object. This material mainly determines the reflection properties of the radar signal.

These triangular networks may not only be exported from existing simulators, but 3D data from game engines or computer games may also be used directly.

Furthermore, realistic 3D data may be generated from map services with appropriate software. It is also possible to create an accurate image of the real environment from the data of high-resolution lidar sensors or on the basis of photogrammetry. With the appropriate effort, an enormously large and theoretically unlimited amount of 3D environment data may thus be generated.

FIG. 3 shows a simulation of a real measurement scene by means of a 3D graphics program. FIG. 3 shows the real measurement scene 101 and a measurement scene 201 patterned on this measurement scene 101 in a simulation environment.

Moving objects may also be exported, for example, by animations or created themselves by means of 3D graphics programs.

The simulator preferably supports diffuse and metal-like reflections, Doppler simulations and animations, occlusion and multipath effects, MIMO apertures with flexible radar parameters and/or any 3D meshes from third-party providers.

A simulative generation of objects and/or scenes thus takes place in step S1.

In the simulation, the animation is then moved on step by step and/or discretized for each radar measurement, e.g. for each chirp, and each snapshot is simulated individually. This is comprised by step S2, simulation of sensor raw data.

The simulator operates very similarly to the known SBR principle, in which radar beams (rays) are emitted by predefined transmit antennas, which in turn are reflected by the environment (triangular networks) until they hit a receive antenna defined as a sphere. An IF signal may be generated from the beams received in this way on the basis of the beam length and echo energy and/or amplitude. In the following equation (1), this is described using the example of an FMCW signal. This method may be transferred to OFDM, CW, pulse or other radars or modulation types.

$${S}_{IF} ( t ) = {\sum }_{i = 0}^{N} {A}_{i} ( α , γ ) exp ( 2 π j ( μ t {τ}_{i} + {f}_{c} {τ}_{i} ) ) \qquad Equation ( 1 )$$

In contrast to the known SBR principle, which is usually based on the fact that only a single radar beam hits a triangle and so-called double counts are avoided as far as possible, the simulator is based on a statistical approach which reflects beams in a statistically distributed manner. These material models are established primarily in ray tracing methods of computer graphics, since they are well suited to describing complex surface properties such as roughness and diffuse scattering. Since the signal propagation in automobile radars increasingly behaves like optical beams as a result of the high transmit frequencies of approximately 77 to approximately 300 GHz, effects such as diffraction may be increasingly neglected. In the simulator, these material models may therefore image the environment in a very realistic manner.

In contrast to the typical SBR approach, a very large number of beams are emitted randomly in the simulator in order to generate extremely realistic radar images. This is evident from FIG. 4, which shows a beam pattern 1 which is configured according to a Fibonacci grid and a beam pattern 2 which is uniformly distributed on a spherical surface.

An example of a simulator may be found in the following publication: “C. Schüßler, M. Hoffmann, J. Bräunig, I. Ullmann, R. Ebelt and M. Vossiek, “A Realistic Radar Ray Tracing Simulator for Large MIMO-Arrays in Automotive Environments,” in IEEE Journal of Microwaves, vol. 1, no. 4, pp. 962-974, Oct. 2021, doi: 10.1109/JMW.2021.3104722”.

The simulation of moving objects and/or the simulation of Doppler and/or micro-Doppler signatures may be made possible in that the environment is first sampled with an initial simulation and the corresponding beam hits are kept in the memory. In the subsequent Doppler simulations, radar beams are then transmitted to exactly the same positions. If the beams were always transmitted randomly for each Doppler snapshot and thus to slightly different positions, this would lead to phase distortions in the Doppler spectrum, which makes a meaningful use hardly possible.

As a result, moving targets or objects may also be annotated particularly well. Information about the movement of the object is preferably already contained in the annotation.

In particular, annotations or labels for the movement may thus also be generated directly. This may take place in a very detailed manner, for example, in the case of a human being.

Each reflection point preferably has its own, in particular vectorial, velocity information. This information is substantially improved compared to the information that an object moves at a specific speed.

A perfect annotation of the micro-Doppler signature is preferably generated. This is not possible in the prior art and is very valuable, in particular for radar systems, since the micro-Doppler signature is typically mainly used in artificial intelligence applications in order to classify and/or segment.

FIG. 5 now shows a view of a three-dimensional simulation of a measurement scene 201, a view of a radar image 215 based thereon and a view of an enhanced radar image 240 based thereon.

FIG. 6 shows a view of a real measurement scene 101, a view of a radar image 115 based thereon and a view of an enhanced radar image 140 based thereon.

In order to avoid multiple simulations, only a single simulation may be carried out and the length of the radar beams may be changed subsequently. Due to the fact that the geometry and the movement of all objects are known beforehand, only each radar beam is associated with each triangle and object and stored, wherein the length thereof may be adapted subsequently in the IF signal generation. This procedure was implemented for radar simulations based on the image approach and is referred to there as dynamic ray tracing.

This procedure is illustrated in FIG. 7. There, an efficient simulation of multiple antennas is shown schematically. In order to avoid phase errors, the transmitted beams from all antennas and in each simulation step (chirp) may be calculated such that they respectively hit the triangle at the same point. This is shown in FIG. 7. The beam TF emitted by the transmit antenna T hits the facet F at the same point as the beam TR1 emitted by the transmit antenna T. Only the beam TR1 is further simulated. For further optimization, it is sufficient to simulate only one antenna combination and to calculate the beam length for all other antennas.

A similar optimized procedure may be applied for large antenna arrays. Instead of simulating all antenna combinations, only a single antenna may be simulated and the beam length for all other combinations may be calculated.

With appropriate computer hardware, an arbitrary amount of very realistic radar simulations with arbitrary parameters may be generated.

In order to be able to train artificial intelligences such as neural networks on the basis of simulated data, a digital twin is built up in the simulation environment in the first step. Antenna configuration, relevant hardware properties and signal parameters are preferably adopted in a realistic manner for the simulation. In addition, influences due to the antenna characteristics or calibration artifacts may also be taken into account.

During the simulation, individual signal components and/or beams may be directly annotated since all simulated objects are known and/or may be reconstructed. Subsequently, signals may be generated which serve directly as ground truth.

It is known to use simulations for automatic annotation for object detections. As a result, for example, the objects in a range Doppler image are annotated by means of bounding boxes in order to train a YOLO network.

However, this is not sufficient to classify complex measurement scenarios since, for example, side lobes, noise and multiple reflections are not taken into account here, which may only be described insufficiently by simple bounding boxes and also cannot be annotated manually or automatically until now.

By means of the advanced digital twin, a noise reduction may be improved in which noise components, side lobes, etc. may be annotated.

Digital twins may not only be used for the classification and/or segmentation of data. They may also be used to improve raw data signal processing as a whole. This includes, inter alia:
the elimination of undesired multiple reflections;
the reduction of electronic noise;
the artificial improvement of the antenna emission characteristic;
the elimination of ambiguities, for example in the angular or Doppler dimension;
the reduction of calibration errors by crosstalk of the antennas.

Signal improvement may be achieved by simulating not only radar data sets that are as close as possible to the real sensor. Preferably, a sensor is additionally simulated that has a higher resolution, for example due to a larger antenna array, and whose simulated hardware and simulated world are free of the above-mentioned artifacts and interferences.

Higher resolution may be achieved, for example, by simulating substantially more antennas than in the original sensor. The number of antennas may be higher than would be possible with any real sensor. Interferences due to multipath propagation, such as multipath reflections, may be eliminated by limiting the number of possible beam reflections.

The other described artifacts and interferences may be eliminated in a similar manner. The additionally simulated sensor may be referred to as an Advanced Digital Twin.

If the signals from both virtual sensors are present, any artificial intelligence may be trained in order to improve the data of the digital twin.

This takes place by using the data of the Advanced Digital Twin as ground truth data. This increases not only the resolution and speed, distance and angle unambiguity of the input sensor, but also avoids and/or suppresses or at least reduces any or all of the above-mentioned artifacts.

If the radar simulations are sufficiently close to reality, the artificial intelligence thus taught and/or trained may be applied directly to a real sensor. This may be found for some of the above-mentioned artifacts in the following publication: “C. Schüßler, M. Hoffmann, I. Ullmann, R. Ebelt and M. Vossiek, “Deep Learning Based Image Enhancement for Automotive Radar Trained With an Advanced Virtual Sensor,” in IEEE Access, vol. 10, pp. 40419-40431, 2022, doi: 10.1109/ACCESS.2022.3166227”.

In the simulation, each received beam may be associated with its environment, in which it reflects from the environment until it hits a receive antenna. Each beam may carry any metadata, such as the beam propagation time or the beam energy.

Preferably, this metadata is extended by a list of object identifiers (object IDs) which indicate, for example, at which specific object a beam was reflected, and preferably by all information, such as, for example, vectorial speed, preferably of each image point or beam, noise, temperature, material property and/or color, which are required for labeling or annotation. Thus, during the generation of the radar signals, it is completely known which beam has hit which object type and which entity. Thus, the data may be annotated in such a way that not only different object classes, such as, for example, pedestrians and cyclists, may be distinguished from one another on the basis of the labels, but also individual objects of the same object class, such as, for example, individual pedestrians among one another.

Since the simulated IF signal, such as, for example, in equation (1) for FMCW signals, is created by adding up the signal component for each individual beam length, IF signals may already be created for each individual object before the actual processing, and may therefore be automatically classified and/or annotated in the subsequent signal processing. This also means that each side lobe, each multiple reflection and, without exception, each other associated signal component, such as the speed, may be uniquely assigned to an object.

Conventional problems in the correct assignment of signal components and objects, which arise, for example, as a result of occlusion, may thereby be directly eliminated. In the exemplary case of a pedestrian who is located behind a wall, there would be no pedestrian in the beam data and the segmentation of a pedestrian would be correctly excluded from the ground truth data. Even far more complex scenarios may be solved thereby, e.g. if a pedestrian is walking or standing behind a car, and can therefore only be recognized by multiple reflections in the radar signal.

Problems of this type cannot be solved by other reference sensors such as, for example, lidar and camera systems, since they are subject to different beam physics or have different data processing. A simple annotation in which the 3D geometry is placed directly on the radar images is also not sufficient in this case since not all signal components in the spectrum may be assigned since there is no spatial affiliation in the case of side lobes and multipath propagation.

The annotation of the radar signal and/or the spectral data may, on the one hand, be totally complete for the first time since, without exception, each beam contributing to the radar signal contains all object information and may be used as a perfect label. On the other hand, the annotation may be implemented in a fully automated and computation-efficient manner as part of the simulation process chain, such that no additional manual effort is necessary.

Preferably, an almost unlimited number of realistic, perfectly annotated data may be generated. As a result, the three most important criteria of data quality and quantity and quality of the annotation for the teaching or training of artificial intelligences such as neural networks are met to an unparalleled extent. The resulting artificial intelligences may consequently stand out significantly from the previous prior art and resolve substantially more complex scenarios and, for example, realize a significantly more complex segmentation, such as, for example, a complete panoptic segmentation.

The presented procedure may be applied not only to radar sensors, but also to a large number of other sensor systems, such as camera, lidar or ultrasound systems.

For camera data, superresolution algorithms are usually trained by reducing the resolution of an existing sensor and using the associated images as input data. The data with the original resolution are then used as ground truth. Existing ray tracing simulations in computer graphics are, however, already very mature and realistic. It is therefore obvious to alternatively simulate camera images with higher resolutions than in conventional cameras. This approach allows the presented principle of the Advanced Digital Twin to be transferred directly.

Lidar systems may also be simulated with ray tracing approaches. Beam tracing is very similar to the simulation of radar data, since the optical lidar beams have a smaller wavelength than radar beams, only the material properties have to be adapted. In addition, multiple reflections play a subordinate role in lidar data. The resolution of a lidar system may be virtually improved, for example, by increasing the number of beams or the rotation rate and/or measurement rate of the system and thereby generating a denser point cloud. According to the method described above, these data may also be used directly as ground truth data.

In contrast to radar and lidar systems, ultrasonic sensors do not operate with electromagnetic waves, but with acoustic sound, but since the signals are also described as waves, the signal processing for ultrasonic data is very similar and even often identical. Ultrasonic signals may thereby be simulated in a similar manner to radar signals. Only other effects such as diffraction or transmission are to be taken into account here depending on the wavelength, and the simulation environment is to be adapted to the respective parameters. However, the presented approach may be adopted directly after adaptation of the simulation environment.

Any desired sensor fusions of different or identical sensor systems may also be realized. As a result, more comprehensive and complicated sceneries may also be directly simulated in order, for example, to directly train applications for autonomous driving.

The operating principle of the simulation unit is preferably based on the SBR approach. The description of virtual objects and/or the virtual environment preferably takes place via triangular networks. The simulation unit is preferably accelerated via a modern ray tracing engine. A fast and simple placement of virtual objects and/or the virtual environment takes place.

Diffuse and metallic reflections may preferably be simulated on virtual objects and/or in the virtual environment. A Doppler simulation and animations may also take place. The simulation of occlusions and/or multipath effects is preferably possible in the simulation unit. MIMO apertures may be simulated with flexible radar parameters. Any desired networks from third-party providers are conceivable in the simulation.

Particularly relevant fields of use for the invention are, inter alia:
Automotive: Autonomous driving and driver assistance systems (Signal Enhancement, extensive training, classification and/or segmentation of static and dynamic objects and road users, among others);
Smart home applications (detection of humans and movements; fall and presence detection, energy saving techniques, among others);
Medical technology and medical applications (Vital Sign Monitoring, motion analysis (gait, injury, etc.), stress detection, palliative care monitoring, sleep analysis, general diagnostics and monitoring, among others);
Traffic space monitoring (road, passage and parking space monitoring, among others);
Industrial applications (in logistics or robotics applications, among others);
Industrial automation and 6G applications;
Military technology (autonomous robotics, drones, target recognition, among others).

1. A system for detecting, classifying and/or segmenting an object and/or a property of an object with a simulation unit and an artificial intelligence unit, wherein the simulation unit is configured to generate simulated measurement data of a simulated sensor unit about a virtual object and/or a property of a virtual object in a virtual environment and to annotate the virtual object, the property of the virtual object and/or the virtual environment and to generate simulation data therefrom, characterized in that the artificial intelligence unit is configured to detect, classify and/or segment, based on the simulated measurement data and the simulation data, an object and/or a property of an object based on the simulated measurement data or based on other simulated measurement data and/or based on measurement data generated from a real measurement.

2. The system according to claim 1, characterized in that the simulation unit is configured to simulate more than one virtual object with more than one property and/or is configured to completely annotate the virtual object and/or the property of the virtual object or the virtual objects and/or the properties of the virtual objects and/or the virtual environment.

3. The system according to claim 1, characterized in that the system further comprises means, by means of which a generation of the virtual object and/or a generation of the virtual environment takes place by means of 3D information, which was generated from a game engine or based on map information, aerial images, earth remote sensing information and/or measurement data of a camera system and/or a laser scanner or other sensor systems.

4. The system according to claim 1, characterized in that the simulated sensor unit is patterned on a real sensor unit and/or that the simulated sensor unit is improved compared to a real sensor unit, in particular with respect to resolution capability, signal-to-noise ratio and/or unambiguity ranges.

5. The system according to claim 1, characterized in that the simulated sensor unit simulates a radar, a camera, a lidar and/or an ultrasound device.

6. The system according to claim 1, characterized in that the simulated, other simulated or measurement data generated from a real measurement are image data and/or that the artificial intelligence unit is configured to improve raw and processed sensor signals in the measurement data.

7. The system according to claim 1, characterized in that the environment is a dynamic, three-dimensional environment.

8. The system according to claim 1, characterized in that the artificial intelligence unit is part of a vehicle and/or that the measurement data generated from the real measurement was generated by a radar, a camera, a lidar and/or an ultrasound device.

9. A method for detecting, classifying and/or segmenting an object and/or a property of an object with a system according to claim 1, the method comprising:
a) generating simulated measurement data of a simulated sensor unit about a virtual object and/or a property of a virtual object in a virtual environment;
b) annotating the virtual object, the property of the virtual object and/or the virtual environment and generating simulation data,
characterized in that,
based on the simulated measurement data and the simulation data, an object and/or a property of an object is detected, classified and/or segmented based on the simulated measurement data or based on other simulated measurement data and/or based on measurement data generated from a real measurement.

10. A method for training an artificial intelligence unit of a system according to claim 1, characterized in that the artificial intelligence unit is trained to detect, classify and/or segment, based on simulated measurement data and the simulation data, an object and/or a property of an object based on the simulated measurement data or based on other simulated measurement data and/or based on measurement data generated from a real measurement.

11. A non-transitory, computer-readable medium comprising a program code that, when the program code is executed on the system according to claim 1, cause the system to perform a method for detecting, classifying and/or segmenting an object and/or a property of an object, the method comprising:
a) generating simulated measurement data of a simulated sensor unit about a virtual object and/or a property of a virtual object in a virtual environment;
b) annotating the virtual object, the property of the virtual object and/or the virtual environment and generating simulation data,
characterized in that,
based on the simulated measurement data and the simulation data, an object and/or a property of an object is detected, classified and/or segmented based on the simulated measurement data or based on other simulated measurement data and/or based on measurement data generated from a real measurement.

12. (canceled)
